(19) United States
(12) Patent Application Publication
(10) Pub. No.: US 2019/0235873 A1
(43) Pub. Date: Aug. 1, 2019

(54) SYSTEM AND METHOD OF REDUCING COMPUTER PROCESSOR POWER CONSUMPTION USING MICRO-BTB VERIFIED EDGE FEATURE

(71) Applicant: Samsung Electronics Co., Ltd., Suwon-si (KR)

(72) Inventors: James David DUNDAS, Austin, TX (US); Gerald David ZURASKI, Jr., Austin, TX (US); Karthik SUNDARAM, Austin, TX (US)

(21) Appl. No.: 16/019,502

(22) Filed: Jun. 26, 2018

Related U.S. Application Data
(60) Provisional application No. 62/624,108, filed on Jan. 30, 2018.

(51) Int. Cl. G06F 9/38; G06F 9/30; G06F 12/0875

(52) U.S. Cl. CPC G06F 9/3806; G06F 2212/452; G06F 12/0875; G06F 9/30058

(57) ABSTRACT

According to one general aspect, an apparatus may include a front end logic section comprising a main-branch target buffer (BTB). The apparatus may also include a micro-BTB separate from the main BTB, and configured to produce prediction information associated with a branching instruction and mark prediction information as verified when one or more conditions are satisfied. Wherein the front end logic section is configured to be, at least partially, powered down when the data stored by the micro-BTB that results in the prediction information is marked as previously verified.

### CROSS-REFERENCE TO RELATED APPLICATION

This application claims priority under 35 U.S.C. § 119 to Provisional Patent Application Ser. No. 62/624,108, entitled “SYSTEM AND METHOD OF REDUCING COMPUTER PROCESSOR POWER CONSUMPTION USING MICRO-BTB VERIFIED EDGE FEATURE” filed on Jan. 30, 2018. The subject matter of this earlier filed application is hereby incorporated by reference.

### TECHNICAL FIELD

This description relates to computer architecture, and more specifically to a system and method of reducing computer processor power consumption using micro-branch translation buffer (BTB) verified edge feature.

### BACKGROUND

Central processing units (CPUs) normally predict the direction and target of branch instructions early in a processing pipeline in order to boost performance. Information about the type, location, and target of a branch instruction is typically cached in a branch target buffer (BTB), which is accessed using an instruction fetch address, and uses a content addressable memory (CAM) to detect if the BTB contains a branch that maps to the current fetch window. A BTB can also use a set associative structure to detect whether the BTB contains a branch that maps to the current fetch window. A conventional BTB is typically a large structure, and when combined with a branch direction predictor, results in at least a one cycle penalty (i.e., bubble) for a predicted-taken branch. In some cases, the conventional BTB may even incur a penalty for a predicted not-taken branch.

Some attempts have been made to address the penalty by using a loop buffer or similar structure to hide the predicted-taken branch bubble, but these approaches have limitations. Loop buffers require that all of the instructions in the loop fit within the loop buffer, not just the branch instructions. Smaller and simpler BTBs that do not incorporate a conditional branch predictor cannot accurately predict branches with dynamic outcomes and will result in wasted performance and energy. Furthermore, smaller and simpler BTBs that do not employ links will waste energy on CAM operations.

### SUMMARY

According to one general aspect, an apparatus may include a front end logic section comprising a main-branch target buffer (BTB). The apparatus may also include a micro-BTB separate from the main BTB, and configured to produce prediction information associated with a branching instruction and mark prediction information as verified when one or more conditions are satisfied. Wherein the front end logic section is configured to be, at least partially, powered down when the data stored by the micro-BTB that results in the prediction information is marked as previously verified.

According to another general aspect, an apparatus may include a front end logic section comprising a main-branch target buffer (BTB). The apparatus may also include a micro-BTB separate from the main BTB, and configured to produce prediction information associated with a subroutine call instruction and mark prediction information as verified when one or more conditions are satisfied. Wherein the front end logic section is configured to be, at least partially, powered down when the data stored by the micro-BTB that results in the prediction information is marked as previously verified.

The details of one or more implementations are set forth in the accompanying drawings and the description below. Other features will be apparent from the description and drawings, and from the claims.

A system and/or method for computer architecture, and more specifically to a system and method of reducing computer processor power consumption using micro-branch translation buffer (BTB), substantially as shown in and/or described in connection with at least one of the figures, as set forth more completely in the claims.

### BRIEF DESCRIPTION OF THE DRAWINGS

FIG. 1 is a block diagram of an example embodiment of a system in accordance with the disclosed subject matter.

FIG. 2 is a block diagram of an example embodiment of a system in accordance with the disclosed subject matter.

FIG. 3 is a block diagram of an example embodiment of a system in accordance with the disclosed subject matter.

FIG. 4a is a flowchart of an example embodiment of a technique in accordance with the disclosed subject matter.

FIG. 4b is a flowchart of an example embodiment of a technique in accordance with the disclosed subject matter.

FIG. 5 is a schematic block diagram of an information processing system that may include devices formed according to principles of the disclosed subject matter.

Like reference symbols in the various drawings indicate like elements.

### DETAILED DESCRIPTION

This application incorporates by reference the subject matter of the earlier filed application Patent Publication No. 20170068539, entitled “HIGH PERFORMANCE ZERO BUBBLE CONDITIONAL BRANCH PREDICTION USING MICRO BRANCH TARGET BUFFER” filed on Feb. 18, 2016.

Various example embodiments will be described more fully hereinafter with reference to the accompanying drawings, in which some example embodiments are shown. The present disclosed subject matter may, however, be embodied in many different forms and should not be construed as limited to the example embodiments set forth herein. Rather, these example embodiments are provided so that this disclosure will be thorough and complete, and will fully convey the scope of the present disclosed subject matter to those skilled in the art. In the drawings, the sizes and relative sizes of layers and regions may be exaggerated for clarity.

It will be understood that when an element or layer is referred to as being “on,” “connected to” or “coupled to” another element or layer, it may be directly on, connected or coupled to the other element or layer or intervening elements or layers may be present. In contrast, when an element is referred to as being “directly on”, “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, and so on may be used herein to describe various elements, components, regions, layers and/or sections, these elements, components, regions, layers and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of the present disclosed subject matter.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” may encompass both an orientation of above and below. The device may be otherwise oriented (rotated 90 degrees or at other orientations) and the spatially relative descriptors used herein interpreted accordingly.

Likewise, electrical terms, such as “high” “low”, “pull up”, “pull down”, “1”, “0” and the like, may be used herein for ease of description to describe a voltage level or current relative to other voltage levels or to another element(s) or feature(s) as illustrated in the figures. It will be understood that the electrical relative terms are intended to encompass different reference voltages of the device in use or operation in addition to the voltages or currents depicted in the figures. For example, if the device or signals in the figures are inverted or use other reference voltages, currents, or charges, elements described as “high” or “pulled up” would then be “low” or “pulled down” compared to the new reference voltage or current. Thus, the exemplary term “high” may encompass both a relatively low or high voltage or current. The device may be otherwise based upon different electrical frames of reference, and the electrical relative descriptors used herein should be interpreted accordingly.

The terminology used herein is for the purpose of describing particular example embodiments only and is not intended to be limiting of the present disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present disclosed subject matter.

Unless otherwise defined, all terms (including technical and scientific terms) used herein have the same meaning as commonly understood by one of ordinary skill in the art to which this disclosed subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments will be explained in detail with reference to the accompanying drawings.

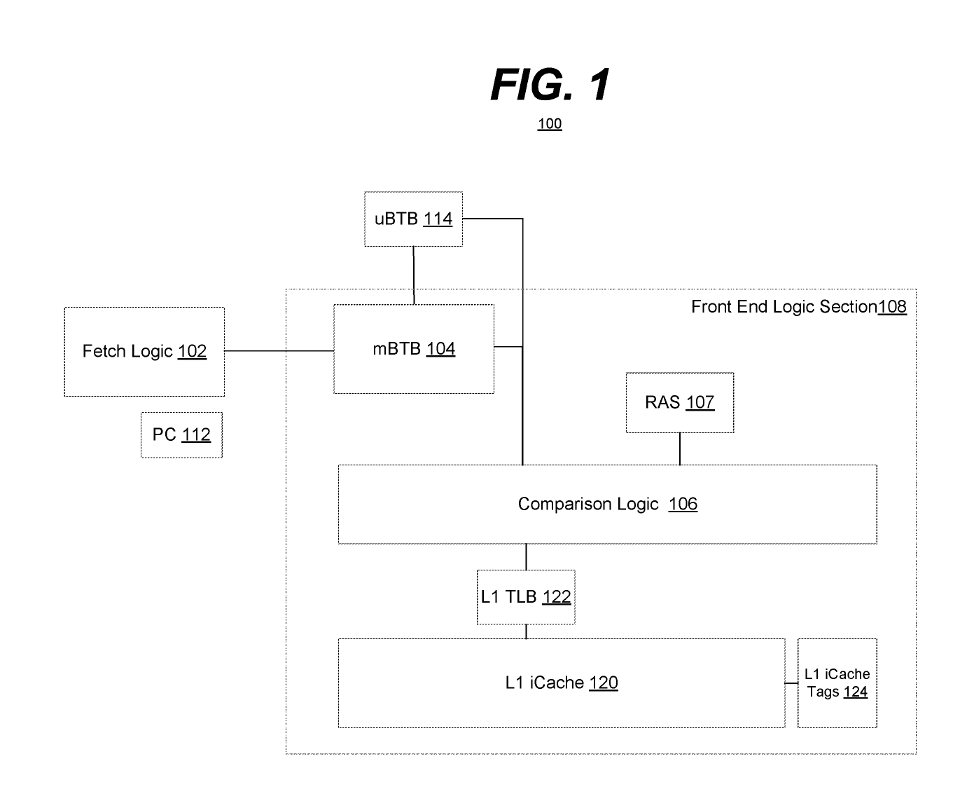

FIG. 1 is a block diagram of an example embodiment of a system 100 in accordance with the disclosed subject matter. In various embodiments, the system 100 may include a computing device, such as, for example, a processor, system-on-a-chip (SoC), laptop, desktop, workstation, personal digital assistant, smartphone, tablet, and other appropriate computers or a virtual machine or virtual computing device thereof. In various embodiments, the system 100 may employ a pipelined architecture including various pipeline stages.

In such an embodiment, part of the pipeline may include a fetch logic circuit 102 configured to fetch instructions, which are in turn processed by the system 100. The current (for at least that pipe stage) instruction may be held or referenced in a program counter (PC) 112. Generally, as instructions, one after the other, are sequentially fetched, the PC 112 is incremented. However, occasionally, the program does not advance sequentially but jumps or branches to a new location. Traditionally, the usual types of branch instructions include IF statements, Loops, subroutines calls or returns, and so on. Essentially the program reaches a fork in the road of execution and has to decide which path to take.

Because of the pipelined nature of the system 100 this can be very costly. Does the program continue the loop or break out of it? Is the IF statement true or false? These options are generally referred to as the branch being Taken or Not taken. The system 100 could halt all execution until the branch instruction is resolved. However, it is more advantageous for the system 100 to predict how the branch instruction will resolve and then speculatively execute the predicted path. If the prediction is correct, then the system 100 has not wasted anytime. Otherwise, the system 100 has to invalidate all of its speculative work, rewind the machine to the incorrectly predicted branch instruction and proceed down the other execution path. As a result, there is a great need to increase prediction accuracy.

One technique for doing this is a branch target buffer (BTB). A BTB is a memory that is addressable by instruction address (usually the current PC 112) and recounts the way the branch instruction resolved the last time the branch instruction was encountered (either as taken/not taken, or as the target address of the branch). This way the front end logic circuits or section 108 can quickly predict the branch instruction's resolution and proceed.

In the illustrated embodiment, the system 100 may include a main BTB (mBTB) 104 that is generally sized to accommodate a relatively large number of possible addresses (branch instructions) and still be able to return a desired prediction in a relatively quick period of time. In various embodiments, the size may differ, but the general tradeoff between speed and size is understood. As described above, the mBTB 104 may include a table or data structure that includes the address of the branch instruction, the address of the target instruction, and a valid bit or flag. In such an embodiment, the valid bit or flag may indicate that data has been explicitly written into the mBTB 104 and it should be treated as acceptable to use. The valid bit differentiates valid data (which can be relied upon to have meaning) from invalid data (which is assumed to have no meaning; e.g., from an old program run, random bits not reset from system start-up).

The fetch logic 102 may then fetch or retrieve the target instruction indicated by the mBTB 104. In various embodiments, this may involve requesting the target instruction from a cache, such as the level-1 (L1) instruction cache (i-cache or iCache) 120, which is configured to store instructions. In such an embodiment, the L1 iCache may include a series of tags 124 and be associated with a L1 translation look-aside buffer (TLB) 122. In various embodiments, other or multiple cache levels may be used. It is understood that the above is merely one illustrative example to which the disclosed subject matter is not limited.

As the predicted target instruction proceeds through the pipeline of system 100, the comparison logic 106 may be configured to determine if the prediction was correct. Computer processing units (CPUs) (e.g., system 100) generally use the instruction TLBs (e.g., L1 TLB 122) and L1 instruction cache tags 124 to verify that the proper instructions are being supplied to the core from the front end. Did the branch instruction take the path predicted by the mBTB 104? Based upon the answer, the target address in the mBTB may be updated.

Further, in the illustrated embodiment, the system 100 may include a return address stack (RAS) 107 for branch instructions that include a subroutine call. When a subroutine call occurs the return address of the subroutine may be pushed onto the stack 107. When the subroutine is complete and returns (via another branch instruction) that return address may be popped off the stack and used as the target address.

Unfortunately, these components of the front end logic section 108 consume power. It would be desirable to de-power, power down, or turn off as much of the front end logic section 108 as possible, as often as possible.

Traditional methods for doing such have included: (1) not powering up the instruction TLB 122 as long as instruction fetch is confined to the last page that hit in the TLB 122; (2) capturing small loops in a loop buffer and fetching instructions out of the buffer with TLB 122 and L1 instruction tags 124 powered down after the first pass through the loop with all instructions hitting in the loop buffer, TLB 122 and L1 instruction tag arrays 124; and (3) The N most recently used L1 instruction cache 120 lines can be saved in an N-entry L0 instruction cache.

Conversely, in the illustrated embodiment, a micro-BTB (uBTB or μBTB) 114 may be employed, either instead of the above, or in additional to the above or other techniques. As will be seen below the use of the uBTB 114 may differ from the traditional techniques in that: basic address blocks can be marked as VERIFIED even if an individual basic block or group of blocks covered by the uBTB 114 that map to an arbitrarily large number of L1 instruction cache 120 lines and TLB 122 entries that are covered by the instruction TLB 122 and L1 instruction cache 120; unlike option #2 above, the disclosed subject matter is not limited to loops that can be captured in a small loop buffer; and unlike Option #3 above, the disclosed subject matter is not limited to a small number of L1 instruction cache 120 lines that can be captured in an L0 instruction cache. In various embodiments, the disclosed subject matter may cover the entire L1 instruction cache 120 (e.g., 64 kilobytes) if the basic blocks covered by the uBTB 114 are large enough.

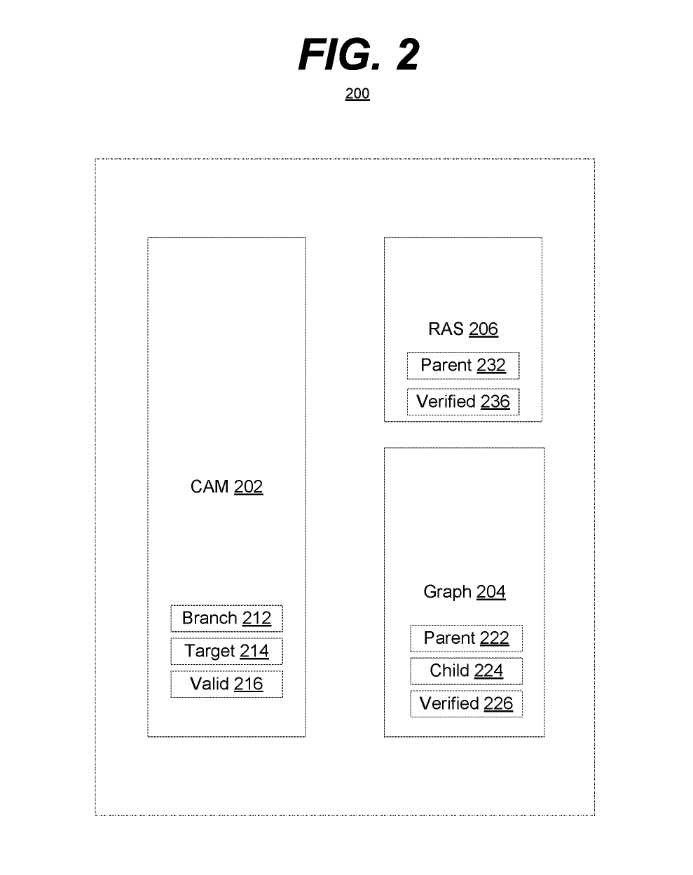

In such an embodiment, the uBTB 114 may include a BTB that is smaller than the mBTB 104, and therefore be faster and consume less power. Further details of the internals of the uBTB 114 are discussed in relation to FIG. 2. In the illustrated embodiment, the uBTB 114 may provide prediction information which can be received by the front end logic section 108 of the system 100. When the information (specifically the prediction information) in the uBTB 114 has been verified as correct, portions of the front end logic section 108 may be powered down, and the uBTB 114 may be relied upon to predict the target instructions. In various embodiments, the portions that may be powered down may include the TLB 122, the L1 instruction cache full-tag or micro-tag arrays 124, or tag comparison logic or the branch target address verification logic 106. In another embodiment, only the L1 instruction cache way predicted by the way prediction logic may be powered up. It is understood that the above are merely a few illustrative examples to which the disclosed subject matter is not limited.

In this context, it is important to note that the terms “Valid” and “Verified” are used as separate and distinct terms. In this context, “Valid” means that the stored data includes data that has been intentionally written and may be used for further processing. For example, if a target instruction has been predicted and written into a BTB, it is considered Valid. The target may ultimately be wrong, but it was the actual prediction made and should be used for fetching data. This is contrasted with invalid data which may just be random bits from when the system 100 powered-up, or from an old program cycle that is no longer relevant. Conversely, in this context “Verified” means that the data (e.g., predicted target) has not just been written intentionally, but has undergone a level of checking and confirmation; that it is not just Valid, but highly likely to be correct.

In more detail, in some embodiments, direct branch targets (computed from the instruction bytes) that are marked Verified must be correct because the direct branch address check logic is disabled (e.g., to save power) if they are marked verified. If a direct branch target as is marked as Verified and it is not correct the processor is functionally broken because the processor will not detect the incorrect target. Indirect branch targets (a target computed from a register or memory value, including both indirect jumps, indirect subroutine calls and subroutine returns) must have been compared to their actual target and Verified as correct, however indirect branch targets can change if the contents of registers or memory change. In such an embodiment, this may be acceptable because the processor back-end will compare the predicted target to the actual target for indirect branches, even if they are marked as verified and redirect the front end if the address changes from the Verified target.

In the illustrated embodiment, when a new branch instruction is encountered, the uBTB 114 or mBTB 104 outputs a predicted target address. As this is the first time the branch instruction/target instruction combination has been encountered, the prediction (or more accurately the link between the first branch instruction and its subsequent child branch instruction) is not considered Verified. The front end logic section 108 is not powered down. Instead the front end logic section 108 performs all of the checking and safe-guarding described above.

As part of that checking and safe-guarding, the front end logic section 108 determines if the prediction is correct and the execution of the path ran smoothly. Specifically, the front end logic section 108 may determine if one or more of the following occur:
that the branch instruction (a.k.a. parent instruction) was correctly predicted,
that all sequential L1 instruction cache 120 accesses were way predicted and correctly predicted by the sequential way predictor,
that all uBTB 114 branch locations, validity and targets all agree with the mBTB 104 and branch target address and branch location verification logic even for branches that are predicted not-taken (in various embodiments, the branch location verification logic may also check for direct branches that were not predicted by uBTB),
that all predicted-taken branch target L1 instruction cache ways were predicted by the uBTB 114 and predicted correctly; in various embodiments, target way predictions may come from the uBTB (e.g., either from the uBTB entry for the branch or from the uBTB's Return Address Stack if the branch is a subroutine return),
that all of the L1 instruction cache 120 accesses hit in the micro-tag, the micro-tag hitting way matched the full address L1 instruction cache tags 124,
that the TLB 122 hit with correct permissions for all pages accessed, until the next or child branch instruction is predicted correctly; and
all of the aforementioned checks are also correct for the next or child branch instruction (The parent's edge as Verified if all fetches from the parent (either from taken parent target and sequential fetches up to and including the child branch or sequentially from not-taken parent and sequential fetches up to and including the child branch) to the child pass the checks. Parent's validity does not depend upon a correct target for the child, it just needs to pass all of the checks up to and including the fetch of the child (but not the child's target or target way)).

In various embodiments, if all of the required checks are fulfilled, the uBTB 114 may mark that prediction as Verified. This is described in more detail in relation to the following figures, but for now a general overview is being given.

In the illustrated embodiment, the second time the branch instruction is encountered (e.g., the second iteration of a loop) the uBTB 114 may issue the prediction and note that the prediction has been marked as Verified. In such an embodiment, the front end logic section 108 (or merely part of it) may be powered down. Thus significant power savings may be achieved. For example, in one embodiment, a power saving of 2-2.5% of the total power budget may be saved, when running various power hungry applications.

Likewise, when a new, unverified branch instruction is encountered, the prediction becomes wrong (e.g., the loop no longer repeats but reaches a break point), or one of a set of predetermined micro-architectural events occur, the front end logic section 108 may be woken up or powered up. Again, the process of re-verifying parent/child branch instruction links may re-occur.

In one specific embodiment, the uBTB 114 may include 128 entries. In such an embodiment, the disclosed subject matter may cover program kernels that fill an entire 64 kilobyte instruction cache, if the basic blocks covered by the uBTB 114 are large enough, and the uBTB 114 is able to correctly predict all the branches within a program kernel. In such an embodiment, this may include program kernels with sophisticated branching patterns, dynamic indirect branches and subroutine calls and returns, as described below.

FIG. 2 is a block diagram of an example embodiment of a system 200 in accordance with the disclosed subject matter. In various embodiments, the system 200 may include a micro-branch target buffer (uBTB or μBTB) 200. The system 200 may be configured to predict, at least in part, the proper programmatic path a branch instruction will take, as described above.

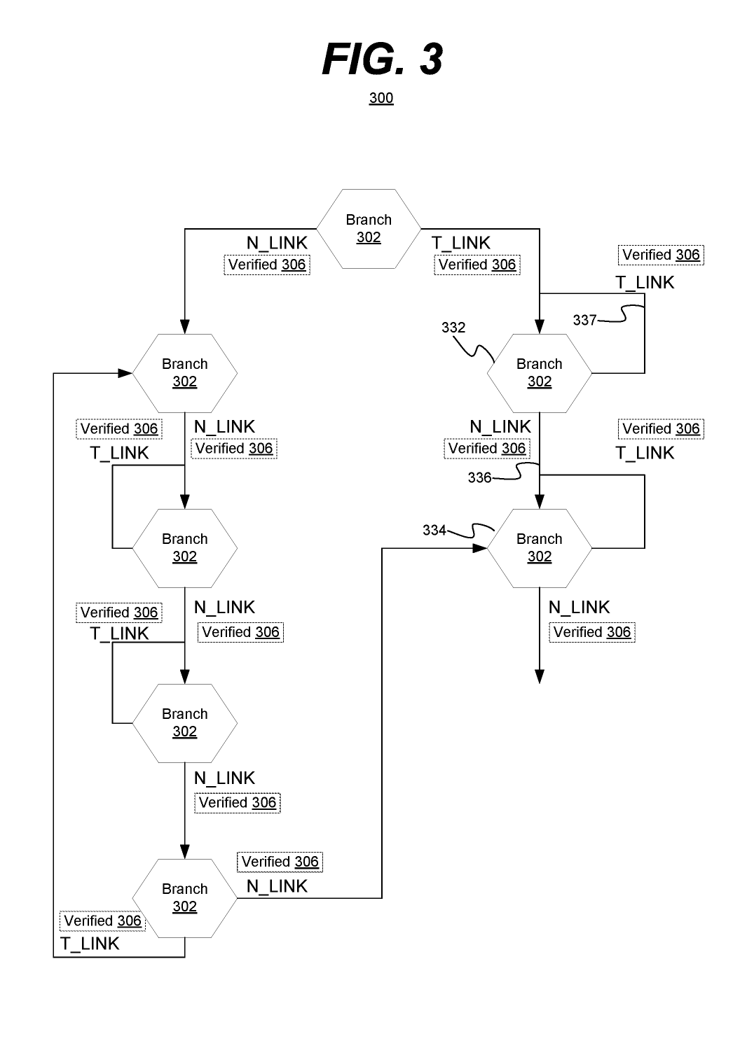

In the illustrated embodiment, the uBTB 200 may include a graph 204. In various embodiments, the graph 204 may be a data structure that represents the structure of possible paths of a given program. The graph 204 may include a number of entries (e.g., 64 entries, 128 entries). The graph 204 may map paths, edges, or links between two (or more) branch instructions, e.g., a parent branch instruction 222 and its (various) child branch instruction(s) 224, such as shown in FIG. 3. The relationship between those two instructions 222 and 224 may be referred to as links or edges. Each of those links or edges may be marked with a Verified bit or flag 226. In various embodiments, the Verified bit or flag 226 may also indicate that the link is not verified.

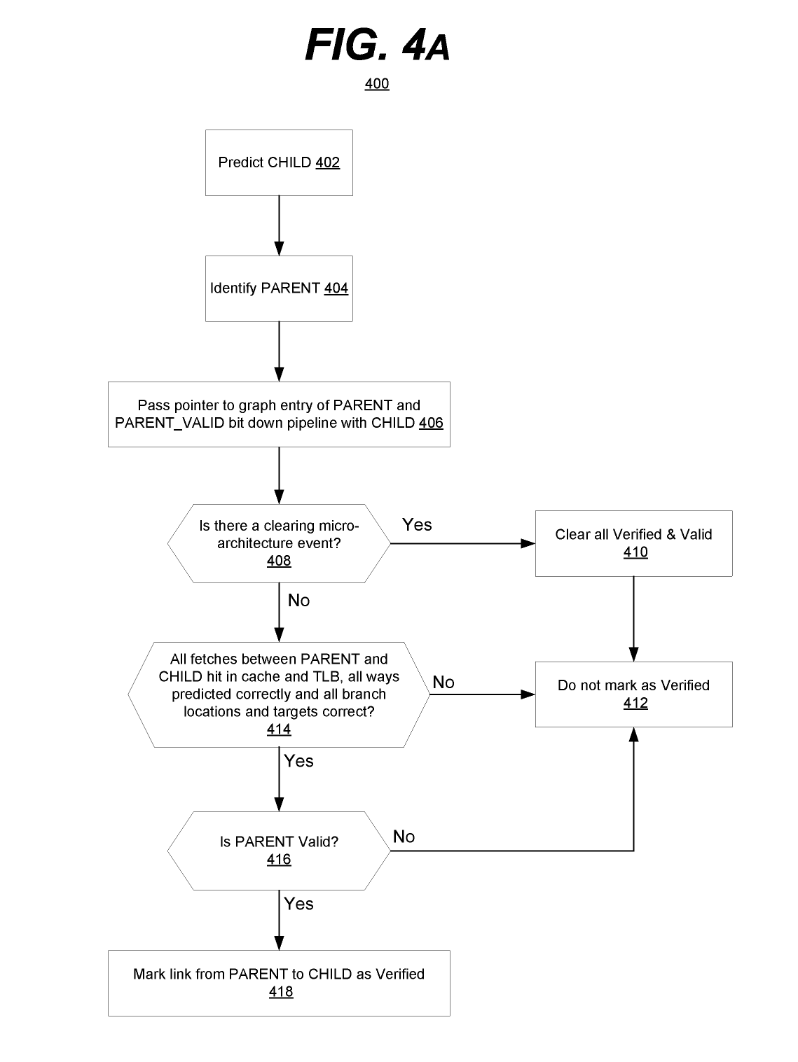

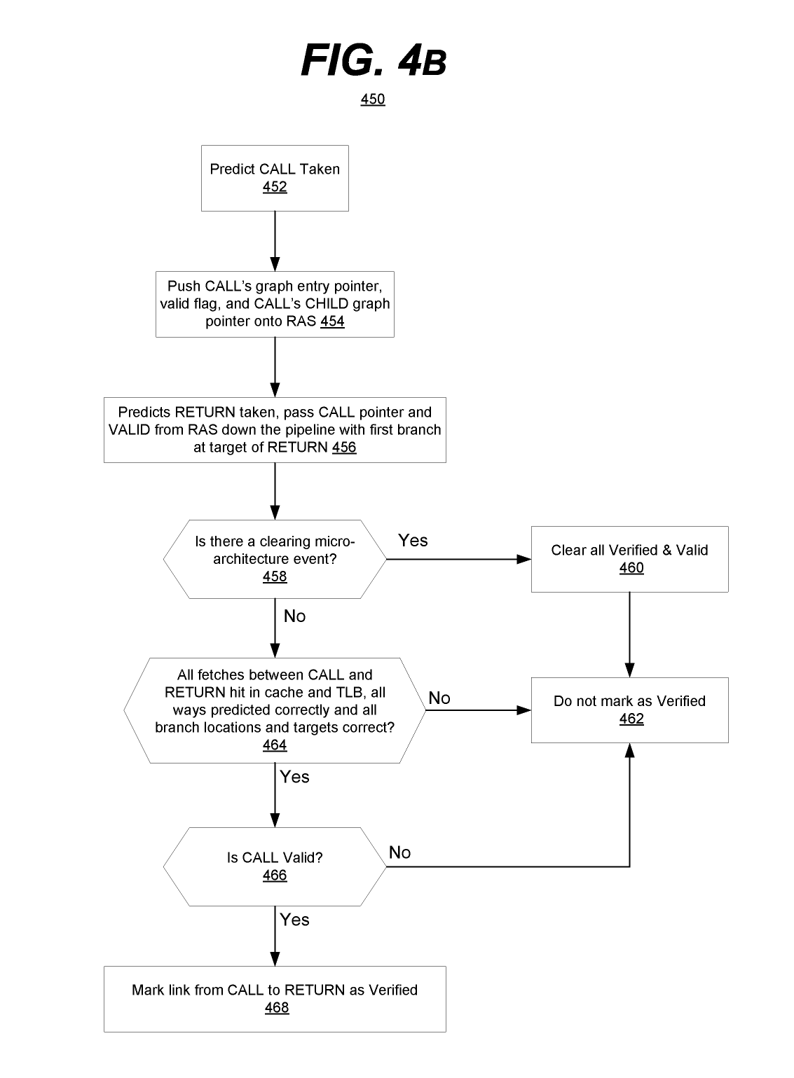

The uBTB 200 may include a return address stack (RAS) 206 configured to store information regarding subroutines calls. In various embodiments, the RAS 206 may include a memory or data structure. As described more in relation to FIG. 4B, the RAS 206 may include, for each entry in the RAS 206, a pointer to the parent instruction data 232 in the Graph 204 and verified bit or flag 236 that is associated with the parent (PARENT_VALID). The RAS 206 may include further data as described below.

FIG. 3 is a block diagram of an example embodiment of a system in accordance with the disclosed subject matter. In various embodiments, the system may include a graph 300, as described above. In various embodiments, the graph 300 may be stored as a data structure (e.g., a linked list, table).

Various embodiments may include a graphical or representation of the branches or branch instructions in a program in which each graph entry 302 represents a single branch instruction. Each branch 302 may be associated with one or more graph edges or links (e.g., links such as T_LINK 336 and N_LINK 337), which point to the next entry or branch in the graph 300.

Each link may be represented as be a pointer (e.g., 6-bits if the graph contains 64 entries) to another entry or branch 302 in the uBTB graph 300. In such an embodiment, links may have certain advantages over CAMs, such as fewer logic gates, lower latency, and reduced power consumption. A traditional branch may have two links associated with it: taken (T_LINK) and not taken (N_LINK). It is understood that the above is merely one illustrative example to which the disclosed subject matter is not limited.

Each link may be associated with a Verified bit or flag 306. As described above, each Verified flag 306 may indicate if the path or edge between two branch instructions 302 has been checked or certified.

As an illustrative example, the branch instruction 332 may be a parent branch instruction. It may be associated with links 336 and 337. Link 337 may be taken (T_LINK) and loop back to the branch instruction 332. Conversely, link 336 may represent the not taken (N_LINK) possibility and may lead to the next branch instruction 334 (a number of non-branch instructions may intervene, but they are not represented in the graph 300). In this example, for the link 336 (N_LINK), the branch instruction 334 would be considered the child branch instruction of the parent branch instruction 332. Likewise, for link 337 (T_LINK), the branch instruction 332 is both its own parent and child. It is understood that the above is merely one illustrative example to which the disclosed subject matter is not limited.

Each of the links 336 and 337 may be associated with their own respective Verified flags 306. In such an embodiment, the link 336 may be Verified (and, if predicted, result in the front end logic section powering down), and the link 337 may not be verified (and, if predicted, may cause the front end logic section to remain or return to being powered up). In another embodiment, both the links 336 and 337 may both be Verified or un-Verified. It is understood that the above are merely a few illustrative examples to which the disclosed subject matter is not limited.

FIG. 4A is a flowchart of an example embodiment of a technique 400 in accordance with the disclosed subject matter. In various embodiments, the technique 400 may be used by or produced by the systems such as those of FIG. 1, 2, 3, or 5. Although, it is understood that the above are merely a few illustrative examples to which the disclosed subject matter is not limited. It is understood that the disclosed subject matter is not limited to the ordering of or number of actions illustrated by technique 400.

Block 402 illustrates that, in one embodiment, the micro-branch target buffer (uBTB or μBTB) may be configured to predict the target address of a child branch instruction.

Block 404 illustrates that, in one embodiment, the uBTB may be configured to identify or remember the previous parent branch instruction. In such an embodiment, the current child branch instruction's parent may be identified.

Block 406 illustrates that, in one embodiment, the uBTB may be configured to, as part of fulfilling its obligations when predicting the target of the child branch instruction, pass, send, or transmit a representation of the parent branch instruction down the pipeline, to the front end logic section, with the prediction of the child branch instruction. In various embodiments, this representation of the parent may include a pointer to a graph entry of the parent branch instruction.

Blocks 408, 414, and 416 illustrate that, in one embodiment, the front end logic section (or a portion thereof) may be configured to make sure that the parent branch instruction was correctly predicted including its target, that all desired cache-related accesses occurred seamlessly, and that no clearing micro-architecture events occurred between the parent and child (as described above. a clearing micro-architecture event would clear all of the Verified bits).

Block 408 illustrates that, in one embodiment, the front end logic section (or a portion thereof) may be configured to determine if any clearing micro-architecture events occurred between the parent and child branch instructions. In various embodiments, the list or set of clearing micro-architecture events may be predefined. In some embodiments, the clearing micro-architecture events may include one or more of the following:
the uBTB contents resetting;
the uBTB feature enable being toggled, or the uBTB being turned on/off;
the uBTB verified edge feature enable being toggled
a new branch or FAR branch (i.e., call to a subroutine located in another memory segment) extension being written to a uBTB graph entry;
a uBTB graph entry being moved to a different entry or invalidated;
a uBTB graph entry being connected to another uBTB entry or its target field being modified;
a uBTB graph entry representing a FAR branch extension being moved to another uBTB entry or its target field being modified;
a uBTB mis-predicting a branch or any pipeline flush farther down the pipeline that indicates that the branch prediction was incorrect, possibly powering up the front end logic section (this may include redirects due to the branch target and location verification logic);
if the uBTB branch target does not agree with the main-BTB (mBTB) branch target, even if branch is predicted not-taken;
if the uBTB branch location does not agree with the mBTB branch location or validity, even if branch is predicted not-taken;
if an Instruction TLB or instruction cache miss has flushed the branch pipeline;
if an Instruction TLB write or invalidation has occurred or is outstanding;
if an instruction cache line snoop is outstanding, a line is snooped out, or a line is invalidated;
if an instruction cache or tag write has occurred; and
if the instruction cache miss buffer is not idle.

It is understood that the above are merely a few illustrative examples to which the disclosed subject matter is not limited.

Block 410 illustrates that, in one embodiment, if any of the set of predefined or predetermined micro-architectural events have occurred, the uBTB may be configured to clear all Verified bits or flags within the graph. In such an embodiment, the Verified bits or flags and Parent Valid flags within the return address stack (RAS) may also be reset or cleared. Further, in some embodiments, at least some of the Valid bits or Flags in the uBTB may also be cleared. In such an embodiment, the Valid bits or Flags associated with the parent branch instructions may be cleared or set to Invalid. Even further, in yet another embodiment, any pending Verified link or Parent Valid flags already in the front end's pipeline may be cleared. In various embodiments, this may include setting the desired flags back to their default states. It is understood that the above are merely a few illustrative examples to which the disclosed subject matter is not limited.

Block 412 illustrates that, in one embodiment, if the illustrated events (e.g., Blocks 408, 414, or 416) occurred, the link between the parent and child branching instructions may not be marked as Verified.

Block 414 illustrates that, in one embodiment, that if no clearing micro-architectural event has occurred the cache activates between the parent branch instruction and the child branch instruction may be checked to determine if they occurred successfully. In various embodiments, this may be done by the front end logic section. In one embodiment, this may include one or more of the following checks: was the parent branch instruction properly predicted?; were all of the instruction cache accesses performed with correctly predicted sequential line or target way predictors?; were all of the instruction cache accesses hits in the micro-tag?; were the micro-tag hitting way matched the full address instruction cache tags?; and were there TLB hits for all pages accessed. These checks may be performed for each instruction between the occurrence of the parent branch instruction and the child branch instruction. It is understood that the above are merely a few illustrative examples to which the disclosed subject matter is not limited.

Block 416 illustrates that, in one embodiment, if these checks are successfully completed, a final check may be made as to whether or not the parent branch instruction is considered Valid. If either of the checks in Blocks 414 or 416 are unsuccessful, as shown by Block 412, the link between the parent and child may not be marked as Verified. As a result, the front end logic section (or portions thereof) may not power down upon the next occurrence of this link.

Block 418 illustrates that, in one embodiment, that if the checks performed as part of Blocks 408, 414, and 416 were successful, the link between the parent and child may be marked as Verified. As a result, the front end logic section (or portions thereof) may be powered down upon the next occurrence of this link.

FIG. 4B is a flowchart of an example embodiment of a technique 450 in accordance with the disclosed subject matter. In various embodiments, the technique 450 may be used by or produced by the systems such as those of FIG. 1, 2, 3, or 5. Although, it is understood that the above are merely a few illustrative examples to which the disclosed subject matter is not limited. It is understood that the disclosed subject matter is not limited to the ordering of or number of actions illustrated by technique 450.

In various embodiments, the subroutines calls (and returns) may represent a special form of branching instructions that may be treated differently (but similarly) to the more normal branching instructions described above. Subroutine calls may result in extra complexity. In one embodiment, the TAKEN edge from the call subroutine to the first branch at or after the call's target is marked verified using the flowchart in FIG. 4A. That edge affects powering up front end from the target of the taken call to the first branch at or after the target of the call. The N (or sequential) edge of the call is marked verified according to FIG. 4B. The N verified edge of the call is pushed onto RAS by the call (parent) and is used to power down all fetches from the target of the corresponding subroutine return to the first branch (child) at or after the target of the return (if it is still marked verified on the RAS top of stack entry when the return is predicted taken). In other words, the return's taken verified edge status is obtained from the RAS top of stack (as it was pushed there by the call).

Block 452 illustrates that, in one embodiment, a subroutine's call taken option may be predicted by the uBTB. Block 454 illustrates that, in one embodiment, the uBTB may be configured to push the graph entry pointer to the subroutine call onto the uBTB's return address stack (RAS). In various embodiments, this may include setting a PARENT_VALID bit. In various embodiments, when uBTB predicts a call as taken, the call may push a pointer to itself onto the RAS. That pointer to the call is the parent of the first branch (the child of the call) predicted by uBTB at or after the target of the corresponding return. The call does not push its child onto RAS, it pushes a pointer to itself. The child uses that parent pointer to mark the call's N edge as verified (or not).

Block 456 illustrates that, in one embodiment, when the subsequent subroutine return (branch) instruction is reached and predicted, the uBTB may pass that parent's or call's graph pointer and PARENT_VALID bit down the front end pipeline with the prediction from the return or child prediction. In various embodiments, this may be similar to that described above in reference to Block 406.

Block 458 illustrates that, in one embodiment, the front end may determine if any clearing micro-architectural events occurred. In various embodiments, this may be similar to that described above in reference to Block 408. In various embodiments, the set of micro-architectural events may be identical to, similar, to or different from those described above.

Block 464 illustrates that, in one embodiment, the front end may determine if all of the aforementioned pipeline checks pass (e.g., predicted targets are correct, all of the instruction cache accesses were performed with correctly predicted sequential line or target way predictors, all of the instruction cache accesses hit in the micro-tag, the micro-tag hitting way matched the full address instruction cache tags, the TLB hit for all pages accessed). In various embodiments, this may be similar to that described above in reference to Block 414. In addition, the Call Valid bit is the parent valid bit that indicates if the parent's (the call) pointer to itself (the call) popped off of the top of the RAS's stack by the return is valid.

Block 466 illustrates that, in one embodiment, the front may determine if the Call Valid bit or flag is set. In various embodiments, this may be similar to that described above in reference to Block 416.

Block 460 illustrates that, in one embodiment, if a clearing micro-architectural event occurred, all of the Verified and Valid bits in the uBTB may be cleared, similarly to that described in reference to Block 410 above. Likewise, Block 462 illustrates that, in one embodiment, the Return instruction may not be marked as Verified, similarly to that described in reference to Block 412 above. Conversely, Block 468 illustrates that, in one embodiment, if the checks were successful, the link between the Call and the child of the Return may be marked as Verified (the N link of the Call), similarly to that described in reference to Block 418 above. Specifically, the N (or sequential) link of the call may be marked verified if all fetches from the target of the taken return to the first branch at or after the target of the return pass the checks. The return itself is not marked as verified. Marking of the N link of the call is done to indicate that all fetches from the taken return to the first branch at or after the target of the return pass the checks.

In various embodiments, once a Verified link is pushed onto the uBTB return address stack by a subroutine call, it may be qualified with the Verified link status of all subsequent branch predictions made by the uBTB while it is the top of stack entry until the corresponding subroutine return pops the uBTB return address stack entry. In such an embodiment, this may cause any non-Verified links predicted by uBTB between the corresponding subroutine call and the subroutine return to prevent the corresponding subroutine return from indicating that its edge is Verified”.

In some embodiments, if the Verified link on the corresponding return address stack entry is still set when the return is predicted taken, the return may indicate that its taken edge is Verified, and the instruction cache micro-tag and full-tag arrays and instruction TLB will not be powered up and only the way-predicted way of the L1 instruction cache will be accessed for all fetches from the target of the return to the next branch (the child).

In some embodiments, a Verified link bit or flag bit in the uBTB return address stack entry may be cleared when a subroutine return pops the entry to prevent the Verified edge indication from being re-used by a different subroutine return if the return address stack becomes mis-aligned or underflows due to the last valid entry being popped. It is understood that the above is merely one illustrative example to which the disclosed subject matter is not limited.

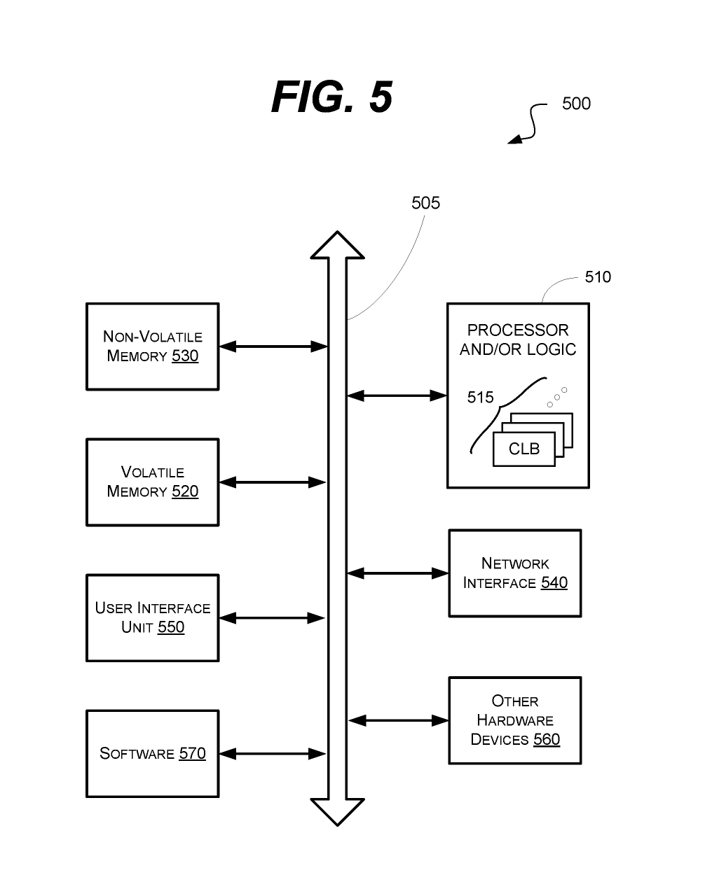

FIG. 5 is a schematic block diagram of an information processing system 500, which may include semiconductor devices formed according to principles of the disclosed subject matter.

Referring to FIG. 5, an information processing system 500 may include one or more of devices constructed according to the principles of the disclosed subject matter. In another embodiment, the information processing system 500 may employ or execute one or more techniques according to the principles of the disclosed subject matter.

In various embodiments, the information processing system 500 may include a computing device, such as, for example, a laptop, desktop, workstation, server, blade server, personal digital assistant, smartphone, tablet, and other appropriate computers or a virtual machine or virtual computing device thereof. In various embodiments, the information processing system 500 may be used by a user (not shown).

The information processing system 500 according to the disclosed subject matter may further include a central processing unit (CPU), logic, or processor 510. In some embodiments, the processor 510 may include one or more functional unit blocks (FUBs) or combinational logic blocks (CLBs) 515. In such an embodiment, a combinational logic block may include various Boolean logic operations (e.g., NAND, NOR, NOT, XOR), stabilizing logic devices (e.g., flip-flops, latches), other logic devices, or a combination thereof. These combinational logic operations may be configured in simple or complex fashion to process input signals to achieve a desired result. It is understood that while a few illustrative examples of synchronous combinational logic operations are described, the disclosed subject matter is not so limited and may include asynchronous operations, or a mixture thereof. In one embodiment, the combinational logic operations may comprise a plurality of complementary metal oxide semiconductors (CMOS) transistors. In various embodiments, these CMOS transistors may be arranged into gates that perform the logical operations; although it is understood that other technologies may be used and are within the scope of the disclosed subject matter.

The information processing system 500 according to the disclosed subject matter may further include a volatile memory 520 (e.g., a Random Access Memory (RAM)). The information processing system 500 according to the disclosed subject matter may further include a non-volatile memory 530 (e.g., a hard drive, an optical memory, a NAND or Flash memory). In some embodiments, either the volatile memory 520, the non-volatile memory 530, or a combination or portions thereof may be referred to as a “storage medium”. In various embodiments, the volatile memory 520 and/or the non-volatile memory 530 may be configured to store data in a semi-permanent or substantially permanent form.

In various embodiments, the information processing system 500 may include one or more network interfaces 540 configured to allow the information processing system 500 to be part of and communicate via a communications network. Examples of a Wi-Fi protocol may include, but are not limited to, Institute of Electrical and Electronics Engineers (IEEE) 802.11g, IEEE 802.11n. Examples of a cellular protocol may include, but are not limited to: IEEE 802.16m (a.k.a. Wireless-MAN (Metropolitan Area Network) Advanced, Long Term Evolution (LTE) Advanced, Enhanced Data rates for GSM (Global System for Mobile Communications) Evolution (EDGE), Evolved High-Speed Packet Access (HSPA+). Examples of a wired protocol may include, but are not limited to, IEEE 802.3 (a.k.a. Ethernet), Fibre Channel, Power Line communication (e.g., HomePlug, IEEE 1901). It is understood that the above are merely a few illustrative examples to which the disclosed subject matter is not limited.

The information processing system 500 according to the disclosed subject matter may further include a user interface unit 550 (e.g., a display adapter, a haptic interface, a human interface device). In various embodiments, this user interface unit 550 may be configured to either receive input from a user and/or provide output to a user. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

In various embodiments, the information processing system 500 may include one or more other devices or hardware components 560 (e.g., a display or monitor, a keyboard, a mouse, a camera, a fingerprint reader, a video processor). It is understood that the above are merely a few illustrative examples to which the disclosed subject matter is not limited.

The information processing system 500 according to the disclosed subject matter may further include one or more system buses 505. In such an embodiment, the system bus 505 may be configured to communicatively couple the processor 510, the volatile memory 520, the non-volatile memory 530, the network interface 540, the user interface unit 550, and one or more hardware components 560. Data processed by the processor 510 or data inputted from outside of the non-volatile memory 530 may be stored in either the non-volatile memory 530 or the volatile memory 520.

In various embodiments, the information processing system 500 may include or execute one or more software components 570. In some embodiments, the software components 570 may include an operating system (OS) and/or an application. In some embodiments, the OS may be configured to provide one or more services to an application and manage or act as an intermediary between the application and the various hardware components (e.g., the processor 510, a network interface 540) of the information processing system 500. In such an embodiment, the information processing system 500 may include one or more native applications, which may be installed locally (e.g., within the non-volatile memory 530) and configured to be executed directly by the processor 510 and directly interact with the OS. In such an embodiment, the native applications may include pre-compiled machine executable code. In some embodiments, the native applications may include a script interpreter (e.g., C shell (csh), AppleScript, AutoHotkey) or a virtual execution machine (VM) (e.g., the Java Virtual Machine, the Microsoft Common Language Runtime) that are configured to translate source or object code into executable code which is then executed by the processor 510.

The semiconductor devices described above may be encapsulated using various packaging techniques. For example, semiconductor devices constructed according to principles of the disclosed subject matter may be encapsulated using any one of a package on package (POP) technique, a ball grid arrays (BGAs) technique, a chip scale packages (CSPs) technique, a plastic leaded chip carrier (PLCC) technique, a plastic dual in-line package (PDIP) technique, a die in waffle pack technique, a die in wafer form technique, a chip on board (COB) technique, a ceramic dual in-line package (CERDIP) technique, a plastic metric quad flat package (PMQFP) technique, a plastic quad flat package (PQFP) technique, a small outline package (SOIC) technique, a shrink small outline package (SSOP) technique, a thin small outline package (TSOP) technique, a thin quad flat package (TQFP) technique, a system in package (SIP) technique, a multi-chip package (MCP) technique, a wafer-level fabricated package (WFP) technique, a wafer-level processed stack package (WSP) technique, or other technique as will be known to those skilled in the art.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

In various embodiments, a computer readable medium may include instructions that, when executed, cause a device to perform at least a portion of the method steps. In some embodiments, the computer readable medium may be included in a magnetic medium, optical medium, other medium, or a combination thereof (e.g., CD-ROM, hard drive, a read-only memory, a flash drive). In such an embodiment, the computer readable medium may be a tangibly and non-transitorily embodied article of manufacture.

While the principles of the disclosed subject matter have been described with reference to example embodiments, it will be apparent to those skilled in the art that various changes and modifications may be made thereto without departing from the spirit and scope of these disclosed concepts. Therefore, it should be understood that the above embodiments are not limiting, but are illustrative only. Thus, the scope of the disclosed concepts are to be determined by the broadest permissible interpretation of the following claims and their equivalents, and should not be restricted or limited by the foregoing description. It is, therefore, to be understood that the appended claims are intended to cover all such modifications and changes as fall within the scope of the embodiments.

What is claimed is:

1. An apparatus comprising:
a front end logic section comprising a main-branch target buffer (BTB);
a micro-BTB separate from the main BTB, and configured to produce prediction information associated with a branching instruction and mark prediction information as verified when one or more conditions are satisfied; and
wherein the front end logic section is configured to be, at least partially, powered down when the data stored by the micro-BTB that results in the prediction information is marked as previously verified.

2. The apparatus of claim 1, wherein front end logic section is at least partially powered up when a new branching instruction is encountered or the prediction information is marked as unverified; and
wherein the front end logic section is configured to attempt to verify (or not) unverified prediction information.

3. The apparatus of claim 2, wherein the micro-BTB is configured to mark all stored branch prediction information as unverified if any one of a predetermined set of events occur that results in any one piece of branch prediction information being marked as no longer verified.

4. The apparatus of claim 1, wherein the micro-BTB includes a graph including one or more entries, and
wherein the graph includes links between at least one parent branching instruction and respective child branching instruction(s).

5. The apparatus of claim 1, wherein the micro-BTB is configured to pass, to the front end logic section, the prediction information; and
wherein the prediction information includes: a parent pointer associated with a parent branching instruction, a valid flag associated with the parent pointer, and a predicted next instruction after the branching instruction.

6. The apparatus of claim 5, wherein the front end logic section is configured to determine if a link between the parent branching instruction and the branching instruction is verified.

7. The apparatus of claim 6, wherein the front end logic section is configured to determine that the link is verified, if, at least, all sequential instruction cache accesses, between the occurrence of the parent branching instruction and the branching instruction, were hit in the instruction cache, were way predicted and correctly predicted, and the valid flag is set.

8. The apparatus of claim 6, wherein the micro-BTB is configured clear at least one verified flag(s) if at least one of a predetermined set of micro-architecture events has occurred in between the occurrence of the parent branching instruction and the branching instruction.

9. The apparatus of claim 1, wherein the branching instruction comprises a call to or return from a subroutine.

10. The apparatus of claim 1, wherein the prediction information is marked as previously verified only after passing a series of pipeline checks; and
wherein the powered off portions of the front end logic section include a translation-look-aside-buffer (TLB), a cache tag array, a cache micro-tag array, and the main BTB.

11. An apparatus comprising:
a front end logic section comprising a main-branch target buffer (BTB);
a micro-BTB separate from the main BTB, and configured to produce prediction information associated with a subroutine call instruction and mark prediction information as verified when one or more conditions are satisfied; and
wherein the front end logic section is configured to be, at least partially, powered down when the data stored by the micro-BTB that results in the prediction information is marked as previously verified.

12. The apparatus of claim 11, wherein the micro-BTB comprises a return address stack configured to store addresses to which a program counter is to return after executing a subroutine; and
wherein the micro-BTB is configured to push a parent subroutine call information onto the return address stack if the subroutine call instruction is predicted to be taken.

13. The apparatus of claim 12, wherein, if all fetched from a target of a taken return to a first branch at or after the target of the return pass a series of checks, the parent subroutine call information comprises a verified flag and a return pointer associated with the return instruction.

14. The apparatus of claim 12, wherein the micro-BTB is configured to, in response to predicting a return from the subroutine, pass, to the front end logic section, the prediction information; and
wherein the prediction information includes: a parent pointer associated with a parent subroutine call instruction, a valid flag associated with the parent pointer, and a predicted return instruction.

15. The apparatus of claim 14, wherein the front end logic section is configured to determine if a link between the parent subroutine call instruction and the return instruction is verified.

16. The apparatus of claim 15, wherein the front end logic section is configured to determine that the link is verified, if, at least, all sequential instruction cache accesses, between the occurrence of the subroutine call instruction and the return instruction, were way predicted and correctly predicted, and the valid flag is set.

17. The apparatus of claim 16, wherein the front end logic section is configured to determine that the link is not verified, if, at least, one sequential instruction cache access, between the occurrence of the subroutine call instruction and the return instruction, missed in the instruction cache, was not way predicted or was not correctly predicted.

18. The apparatus of claim 16, wherein the micro-BTB is configured clear all verified flags if at least one of a predetermined set of micro-architecture events has occurred in between the occurrence of the subroutine call instruction and the return instruction.

19. The apparatus of claim 18, wherein the predetermined set of micro-architecture events comprise one or more events selected from the group consisting essentially of:
a micro-BTB reset,
a micro-BTB branch location, target, or validity does not agree with the main—BTB even if the branch is predicted not-taken,
an instruction cache line being snooped or invalidated or a fill request is outstanding,
an instruction TLB write or invalidation has occurred or a fill request is outstanding,
a change in the micro-BTB settings,
a new branch is written to the micro-BTB,
a micro-BTB entry link is modified,
a micro-BTB target is modified,
an invalidation of a graph entry in the micro-BTB, and
a flush of a branch pipeline.

20. The apparatus of claim 11, wherein the micro-BTB includes a graph including one or more entries, and
wherein the graph includes links between at least one subroutine call instruction and respective return instruction(s).
